(19) United States
(12) Patent Application Publication
(10) Pub. No.: US 2016/0140789 A1
(43) Pub. Date: May 19, 2016

(54) GROUP-DECISION ENGINE

(71) Applicant: RetailMeNot, Inc., Austin, TX (US)

(72) Inventors: Richard Brewster Wickersham, III, Austin, TX (US); Dhruv Rawat, Austin, TX (US); Sixue Chen, Austin, TX (US)

(21) Appl. No.: 14/939,468

(22) Filed: Nov. 12, 2015

Related U.S. Application Data
(60) Provisional application No. 62/079,842, filed on Nov. 14, 2014.
(60) Provisional application No. 62/112,510, filed on Feb. 5, 2015.

(51) Int. Cl. G07C 13/00; G06Q 50/00; H04L 12/58; H04L 29/06; H04W 4/02

(52) U.S. Cl. CPC G07C 13/00; H04L 69/16; H04W 4/021; H04L 51/32; G06Q 50/01

(57) ABSTRACT

A process of expediting a group decision, the process including: instructing computing devices of group members to present options for voting by group members in a plurality of rounds, each round presenting options at a corresponding hierarchical level of a taxonomy, and each round after a first round excluding at least some options based on a group selection in an earlier round; receiving votes of at least some group members in at least some rounds and, in response: adjusting sequences with which options are presented to cause options voted upon favorably by at least some group members to appear earlier in the respective round for other group members; and determining whether a sufficient amount of votes for an option have been received to designate the respective round as complete; and informing a group member of a decision by the group.

### CROSS-REFERENCE TO RELATED APPLICATIONS

The present application is a non-provisional of, and thus claims the benefit of, both U.S. Provisional Patent Application 62/079,842, filed 14 Nov. 2014, and U.S. Provisional Patent Application 62/112,510, filed 5 Feb. 2015, both having the same title as this filing, and both of which are incorporated by reference in their entirety.

### BACKGROUND

1. Field

The present invention relates generally to computer systems for group-decision making and, more specifically, to distributed computing applications by which members of a group reach a decision relatively quickly in the face of a relatively large number of options.

2. Description of the Related Art

Groups make decisions in a variety of scenarios. For instance, groups of friends often collectively choose a restaurant at which to meet for dinner. Or groups of friends may choose a gift for someone, the gift being from the group, and requiring selection of a gift by the group. Often groups plan trips together, which frequently entails multiple group decisions ranging from the destination, to lodging and activities. Group decisions also arise in other contexts, including decisions within the workplace, e.g., choosing a vendor to provide software for a group of users, or in schools, e.g., arriving at a strategy for a group project.

As many have experienced in these scenarios, making decisions as a group is difficult, particularly among larger groups facing a large number of options. Decision making is often challenging because groups often seek to account for diverse individual preferences. Different group members often rank candidates differently. Complicating the process, group members often have varying levels of conviction about their preferences. Some members may have strong favorable feelings toward a candidate, while others are relatively indifferent to a given option or are strongly opposed. The problem is often made worse when groups face large sets of options. People often struggle to parse and digest relatively large number of options, especially when making purchases, and are often cognitively overloaded through the process. Traversing large sets of options can be taxing and unpleasant for groups.

The challenges of group decision making are evident in empirical analyses. Some surveys suggest that this is Millennials' greatest pain-point when making experiential purchases in a group. Further, some testing reveals group decision making can take from five-minutes to an entire day for some social groups. Thus, testing shows group decisions can be a stressful and unenjoyable.

Problems with group decision making are long felt and recognized as, in some forms, intractable. Group decision making remains inefficient despite extensive academic study in the field of social choice theory, which seeks to understand the complex behaviors that emerge as groups seek to select a “best” option among a set of candidates. Theorems in the field, such as Arrow's impossibility theorem, document in mathematical form examples of why group consensus is difficult to achieve. Other issues are documented in the 2004 book by psychologist Barry Schwartz, titled “The Paradox of Choice—Why More is Less,” published by Harper Perennial, which catalogs some of the diverse approaches different members in a group may take when evaluating options.

To the extent groups have attempted to mitigate these challenges, the resulting techniques are often slow, expensive, and cumbersome. For instance, communication within a group facilitates efforts to accommodate diverse individual preferences, but the volume of communication for a decision tends to grow rapidly as the group scales, as those on email chains in which a group decision is being made can often attest. In-person group-meetings mitigate these communication costs, but introduce additional coordination costs, as in-person meetings often introduce new group decision making choices—like where and when to meet- and impose travel and time costs for the meeting. Further, presenting options to the group and tracking and analyzing individual choices is an unpleasant and tedious task, particularly when a large number of options are present.

### SUMMARY

The following is a non-exhaustive listing of some aspects of the present techniques. These and other aspects are described in the following disclosure.

Some aspects include a process of expediting a group decision, the process including: instructing computing devices of group members to present options for voting by group members in a plurality of rounds, each round presenting options at a corresponding hierarchical level of a taxonomy, and each round after a first round excluding at least some options based on a group selection in an earlier round; receiving votes of at least some group members in at least some rounds and, in response: adjusting sequences with which options are presented to cause options voted upon favorably by at least some group members to appear earlier in the respective round for other group members; and determining whether a sufficient amount of votes for an option have been received to designate the respective round as complete; and informing a group member of a decision by the group.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a group-decision engine;

FIG. 2 illustrates an example of a process performed with the group-decision engine of FIG. 1;

FIGS. 3-18 illustrate example user interfaces of a group-decision engine native application; and

FIG. 19 illustrates an example of a computer system by with the above processes and components may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the Inventors had to both invent solutions and, in some cases just as importantly, recognize problems overlooked (or not yet foreseen) by others in the fields of computer science and social choice theory. Indeed, the Inventors wish to emphasize the difficulty of recognizing those problems that are nascent and cross-disciplinary, as such problems will become much more apparent in the future should trends in industry continue as the Inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

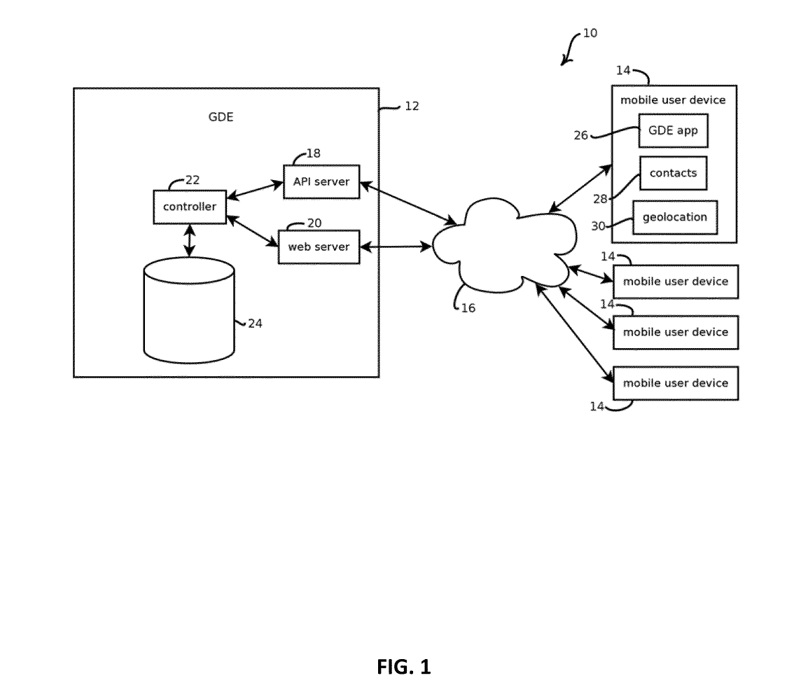

FIG. 1 illustrates an example of computing environment 10 including a group-decision engine 12 (GDE, such as a server system for a distributed application, the distributed application including software running on both a server, like a GDE, and multiple mobile devices, like GDE clients) operative to mitigate some of the above-described problems.

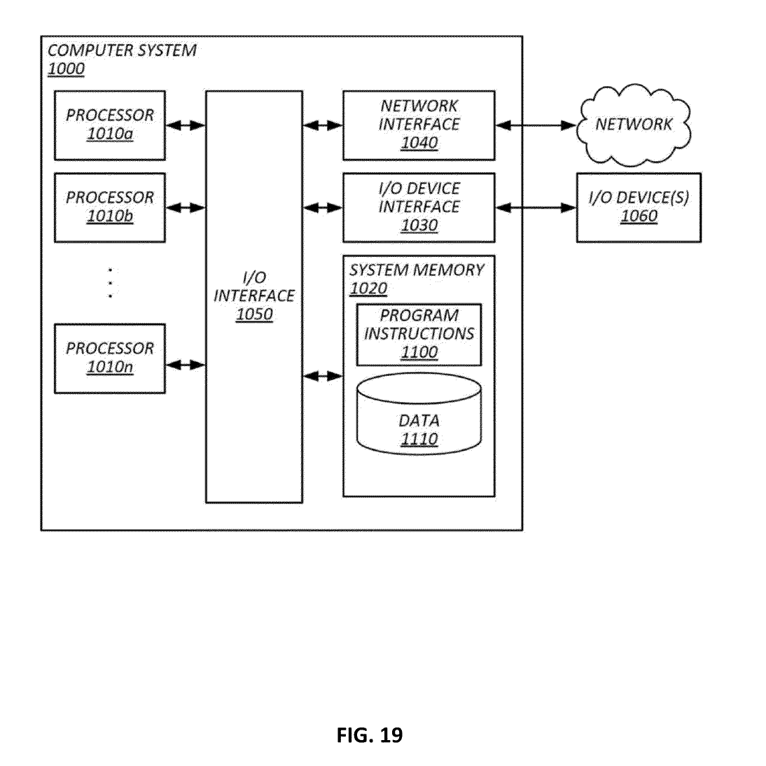

The computing environment 10 may include a plurality of mobile user devices 14 of users in a group, the Internet 16 and various other networks, like local area networks and cellular networks. In some cases, the group decision engine 12 may include an application program interface (“API”) server 18, a web server 20, a controller 22 that implements the GDE processes described below, and a data repository 24 for storing user profiles, votes, and content related to options in decisions. In some cases, the mobile user devices 14 may include a GDE application 26, a repository of contact information 28, and a geolocation module 30 operative to indicate the current geolocation of the mobile user device 14, for instance based on global positioning signals or cellular tower triangulation. In this example, four mobile user devices 14 are shown as part of a single group that will make a decision, but it should be understood that embodiments are consistent with substantially larger scales. For example, it is expected that commercial implementations may process thousands or tens of thousands of group decisions, in some cases being made concurrently, for hundreds of thousands or millions of user devices distributed over a relatively large geographic area, like the entire United States, North America, or the world. The mobile user devices 14 may be hand-held cellular telephones, tablet computers, or other computing devices in some use cases, such as desktop computers, in-dash car computers, set-top boxes, laptop computers, or the like, examples of which are described below with reference to FIG. 19. In some cases, the functionality of the mobile devices 14 described herein may be distributed among multiple mobile user devices within a personal area network, for instance, with notifications and some or all user inputs occurring on a wearable computing device, like a smart watch, and transmission through the Internet 16 occurring via a Bluetooth™ connection to a cellular telephone that relays information via the Internet 16.

In this example, a group of users' mobile devices 14 (or other computing devices) form a group for making a group decision. As illustrated, at least some of the mobile devices may execute a GDE app 26 that communicates with a GDE 12 (e.g., via the API server 18 or (i.e., and/or) web server 20). Other members of the group may view a mobile web page interface for participating in the decision making process, or some users may view a web page on a desktop web browser for engaging in the interactions described herein.

In some embodiments, the GDE 12 provides a service (e.g., mobile, desktop, or web) that allows groups to make a collective decision rapidly, in a way that is sensitive to diverse individual preferences, and in the face of a relatively large set of options relative to the amount of time group members are inclined to dedicate to the decision (e.g., 80 or more options in typical scenarios, 20 or more when group members are pressed for time, or 500 or more when group members are inclined to devote significant time). In some embodiments, the GDE 12 facilitates a game concurrently played by each of the persons involved in the group decision making process. In some embodiments, each person is given (via the Internet for display on that person's mobile device 14 or other client computing device) a series of communal sets of content on which they individually give feedback (again, via the Internet, using their respective user devices), such as votes on options (e.g., categories or items in those categories) described by the content.

These sets of content may be delivered to the persons in a series of rounds. In some cases, earlier rounds are higher-level, broader content (e.g., categories), and later rounds are lower-level, specific content selected based on user responses in earlier rounds (e.g., sub-categories, sub-sub-categories, or items in those categories among which the group ultimately selects). In some embodiments, the final round may contain a set of lowest-level options, e.g., items like restaurants, dishes, destinations, venues, or other items among which groups make selections, one of which will be the decision delivered by the GDE 12. In this way, a group can quickly traverse a very large number of options (like all of the restaurants in a city, all of the bars in a neighborhood, all of the movies in an online movie repository, etc.) in a rapid and efficient manner by iteratively restricting the scope of the search space as subsequent rounds are completed. In some embodiments, the GDE 12 achieves this by taking the real-time (e.g., within a typical request and response time for an Internet-based distributed application, such as less than 1 second) feedback that each individual person is offering and using it to select which content to next serve or show the individual persons to facilitate reaching consensus relatively quickly.

In some embodiments, a GDE system (e.g., GDE apps 26, the GDE 12, a GDE web-interface, or all, in cooperation, in a distributed application) uses feedback from each of the members of a group to guide the group through a set (e.g., a relatively large set, such as more than 80, or more than 500) of options to a final set of decisions, or choices (often a set of one). In some embodiments, the GDE system presents a user interface on user devices 14 with an input by which the respective user enters feedback on a single item at a time, in effect to make a micro-decision about one particular item at a time, as opposed to asking a participant to make a choice on a very large set of options all at once. This makes each micro-decision much more manageable and digestible, though some embodiments are consistent with other techniques by which multiple items are presented simultaneously.

The GDE 12, in some embodiments, uses past decisions of the participant to decide which option to serve (or show, if previously served) them next, creating a personalized experience that, in some cases, is shaped to reduce the amount of effort put forth reaching a group decision. In some embodiments, the GDE 12 not only controls what items are served to each particular participant to decide upon, but also controls (with dynamic readjustment to) the order in which the items are presented. In some cases, the effect of one user's choice relating to an individual option (e.g., a category or item in a category) in a set of options is reported to other user devices 14 in the group (e.g., to a GDE app 26, or to a JavaScript™ event handler communicating via a WebSocket connection of a web page), and the other user devices, in response, may adjust the order in which that option is presented to the other members. For instance, a user vote in favor of an item may cause that item, if determined to be not already presented, to be boosted in a ranking of order in which the items are presented on other user devices 14, or a user vote against an item may cause that item to be, if determined to be not already presented, down-ranked in the order in which the items are presented.

Dynamically re-ranking candidate items as the group makes selections is expected to reduce the aggregate number of decisions the group makes, as the likelihood of a group decision—e.g., everyone approving one of the items, or more than a threshold number of group members (or threshold aggregate score) indicating more than a threshold number of items are selected—being reached earlier in a round is increased. Further, the likelihood of any member of the group needing to decide on every item in a set of candidate options in a round is decreased. Thus, the GDE, in some embodiments, may orchestrate the entire groups' individual interactions to guide the group towards consensus much more quickly than random traversal of the search space. Not all embodiments, however, provide this benefit. Other embodiments may use other techniques, e.g., a static ordering of items, which may offer lower bandwidth usage in exchange for a higher cognitive load on group members.

The GDE 12, in some cases, provides for intra and inter-app communication (e.g., SMS texts, email, OS-notifications, or in-app exchanges) between group members. Consequently, group decisions traversing a relatively large search space can be achieved rapidly (e.g., in less than five minutes for some decisions), without users being physically proximate to one another or needing to schedule and travel to an in-person meeting. That said, embodiments are also consistent with use cases in which decisions are made more slowly, e.g., over several days.

Further, the GDE 12 cooperating with the GDE app 26, in some embodiments, leverages existing data sets to gather and present members of groups options for selection and to configure groups. For instance, some embodiments may present a group leader an interface to add members to a group from the user's contact list (or adjacent nodes of some other social graph, e.g., with a request to the Facebook™ application program interface (API) for friends following OAuth authentication). Some embodiments may present group members the option to add candidates from those group members' contact lists to a group. In some cases, additional contacts for selection are dynamically re-ranked based on historical usage for ordered presentation based on previous selections, e.g., upranking a contact in response to four out of five members of a previous group already being selected, to save the user time in forming the group. Some embodiments may re-rank after each selecting based on the number of past groups in which the contacts appear in the same group as a member that has already been selected. In some embodiments, contacts may be filtered or ranked based on a current distance between the group leader and those contacts, e.g., as reported by instances of the GDE app 26 to the GDE 12 periodically by mobile devices of the contacts, and retrieved from the GDE 12 by the GDE app 26 of the group leader in response to the user initiating a group decision. In other embodiments, all users of the GDE app 26 within a threshold distance, regardless of whether they are in the contact list of the group leader, may be presented to the group leader as users to add to the group.

In another example, existing business listings may be queried via an API, such as the Foursquare™, Google™, or Yelp™ business listings, to retrieve candidate items to present, thereby relieving users of the need to populate a set of candidate items among which the group will choose and facilitating filtering and sorting of the candidates. Other APIs may be used for other types of choices, e.g., Amazon's™ product advertising API, the QPX Express™ API for airline flights, or Expedia's™ EAN API for hotels. In some cases, responsive options may be received in the context of a taxonomy or ontology that labels the items in various categories, sub-categories, and sub-sub-categories, e.g., expressed in a serialized data format appropriate for such formats, like extensible markup language (XML) or JavaScript™ object notation (JSON). The retrieved candidate items may be filtered and ranked for presentation based on previous activities of the group or subsets of the group, e.g., upranking or filtering a subset of the items in response to three previous group decisions involving six of eight members of the group to select the candidate items the group is most likely to choose, or excluding or downranking some of the candidate items based on all members of the group previously rejecting those items on multiple previous occasions.

To further expedite decision making, some embodiments of the GDE present choices in a sequence of hierarchical rounds of group decision making, where earlier rounds rule-in or rule-out entire categories (and in some cases, sub-categories, sub-sub-categories, and sub-sub-sub-categories, etc.) of candidate items, e.g., first deciding on a type of cuisine for dinner—Chinese, Italian, Indian, etc.—before then deciding on a restaurant in a selected one (or more) of those categories in a later round. This may be achieved by serving the content in subsequent hierarchical levels. Each entire group decision (from the full content set to the final decision set), in some embodiments, may take place in a game that is broken up into rounds. Each round in this example may correspond to a different level in the content hierarchy or a different facet in an ontology. In the first round of this example, participants may be served the full content set, which contains members of the highest hierarchical content level. During a round, users in a group may each make choices (e.g., yes, no, indifferent, veto, etc.) regarding each option. Sub-categories or other species of items selected by the group in one round may be presented in the next round (and sub-categories or species of options not selected by the group may be omitted, or otherwise filtered from or downranked in, the set of candidates to present in the next round). In the final round, in some cases, participants may be served a maximally restricted content set, which contains members of the lowest hierarchical content level among the categories selected in previous rounds. Making choices as a group in a hierarchical fashion is expected to expedite choices among relative large sets of options. Some measures of search times may increase at a rate of log(n), where n is the number of items, rather than at a rate of n, where every item is evaluated in a search, when certain types of hierarchies, like binary trees, are used.

The GDE 12 may include a server 18 or 20 that serves content to the group members and consumes their feedback. In some cases, one or more participants are served (or presented, after or during caching of multiple options) the content one option at a time in a sequence ordered by the GDE 12 (or a GDE app 26, which some or all of the user devices 14 may have installed). The group members may each make decisions on each option in that order.

At the outset of a round, in some embodiments, the GDE 12 takes the content set for that round (e.g., either the entire content set or the sub-set corresponding to the decision of a previous round) and orders the content set (and corresponding options described by the content) specifically for each of the participants in the game. In some embodiments, the sequence is different for different participants in some cases to 1) account for previous user histories to up-rank options they are likely to select or 2) randomize the order so that at least one group member is more likely to select a desired option early in a round and elevate that option for others.

Each participant, in some examples, is then served their personally ordered content set for the round. An option may be presented to a participant from the top of the ordered set, and the respective group member may make a decision on that option. As each participant is making decisions on each option, one at a time, this decision feedback may be sent to the server layer, in some embodiments. The decision of a single participant may affect the order of the content sets of all (or a subset) of the other participants in the game, in some cases. In real-time, during the current round, the GDE 12 may reorder each participant's content set of not-yet-presented candidate options in accordance with the decision feedback of the entire (or a subset of the) group. As more items are decided upon, the server layer may continue to reorder the content sets until a decision has been made or all items in the content set have been decided upon.

Reordering may include sending an indication of a selection to other instances of the GDE app 26 or website, which may then re-order based on the selection with routines executing client-side. In some cases, the re-ordering may be configured to guide the participants in particular paths through the search space (e.g., based on paid-placement deals or affiliate sales opportunities). Or in some cases, the re-ordering may be configured to facilitate the traversal of the search space as quickly as possible. In some embodiments, a round is concluded by a decision, which can be triggered either automatically by the GDE 12 (e.g., by determining that conditions indicative of a decision have been achieved or a maximum round time has elapsed) or by one or more of the participants' instances of the GDE app 26 or webpage.

In some cases, the candidate choices may be organized in a taxonomy, e.g., with species and genus relationships, and with leaf nodes of a tree data structure representing the candidate items among which the group is ultimately choosing. One example of such a data structure for restaurants is reproduced below in JSON format by way of example (other serializations may be used, e.g., XML for transmission of the candidate choice taxonomy):

```
{“restaurants”: [
  {“Chinese_restaurants”: [
    {“modern_Chinese”: [
      {“name”: “A+ Chinese Food”},
      {“name”: “Downtown Chinese”}
    ]},
    {“Szechwan”: [
      {“name”: “Chongqing Chinese”},
      {“name”: “Chengdu China Bistro”}
    ]}
  ]},
  {“Italian_restaurants”: [
    {“pizza_places”: [
      {“name”: “Benny's Pizza Parlor”},
      {“name”: “Downtown Pizza”}
    ]},
    {“Sicilian_places”: [
      {“name”: “Sophia's Italian”},
    ]},
    {“Neapolitan_places”: [
      {“name”: “Aragon Buffet”}
    ]}
  ]},
  {“Korean_resturants”: [
    {“name”: “Lee's Garden”},
    {“name”: “Kim Palace”},
    {“name”: “Park Bistro”}
  ]}
]}
```

In this example, the above taxonomy may be obtained by querying an appropriate API of a business listing for restaurants (e.g., by the GDE server in response to a group leader's request to initiate a group decision entered via an instance of the GDE app). The above serialization has relatively few items and fields to keep the data structure concise, but in practice, the taxonomy may include hundreds of items, each with several descriptive attributes (like geolocation, capacity, ratings, comments, URL's to corresponding images, etc.). In some embodiments, the GDE app 26 may query a location service of an operating system of the user's mobile device (e.g., with Apple's™ CoreLocation Framework in iOS™ or Android's™ LocationManager class) and send this location to the GDE 12. In response, the GDE 12 may query the appropriate service via the service's API, composing a request for restaurants in some threshold distance or travel time of the geolocation. The above serialized taxonomy of local restaurants may be retrieved in response by the GDE 12.

The GDE 12 may then further process the taxonomy to remove un-needed fields, cull items (e.g., leaf nodes or whole categories) that user histories indicate are not likely to be selected and score and rank (or otherwise sequence) options at each level (or some levels) of the taxonomy (e.g., randomly or based on user profiles). In some cases, levels may only be sequenced differently for different users in response to the taxonomy including more than a threshold number of options at the respective level, e.g., more than three, to simplify operations in cases where personalized sequences offer diminished benefits. In some cases, leaf nodes may include additional information about each item, such as a geolocation, API-specific unique identifiers, and uniform resource identifiers (URI's) of rich content, such as photos associated with the leaf nodes that may be presented with the client devices 14 when user's select that item in the final round.

In an initial round using the above data, by way of example, members of the group may first select among items at the level of categories of restaurants (Chinese, Italian, and Korean). As users make choices, in some embodiments, the order in which other users are presented with choices may be updated to up-rank items that others selected. Once a round is complete, in some embodiments, selected branches of the taxonomy above may be advanced to the next round (and un-selected branches may be omitted). In some cases, users may be presented with an opportunity to “dig out” a favored item from within a branch of the taxonomy that the group de-selected, e.g., if Korean restaurants generally are to be removed from further consideration with the exception of one place a group member wishes to keep as a candidate. In some cases, the taxonomy may include branches of differing depths. In such cases, some embodiments may perform a round listing only other, deeper branches, to allow those branches to catch up, so that all leaf nodes are presented in a single round to avoid arbitrarily favoring items that are in shallower branches. Or some embodiments may mix leaf nodes and sub-categories in a single round to expedite decision making in cases in which a leaf node is acceptable to the entire group, notwithstanding other branches that the group has not crawled.

In some embodiments, the initial ranking of candidate items may be personalized or randomized (e.g., pseudorandomized, like with a linear shift register), such that candidate items in a round are presented in a different order to different group members, at least initially, until feedback from other group member choices causes some candidate items to rise in ranking among the group and be presented earlier across the group. In some embodiments, the ranking is personalized based on previous user selections, e.g., previous user selections with the same or a similar group at a similar time, to up-rank items that the user is likely to favor. In some cases, a sequence in which each item is to be presented is composed at the GDE 12 or at the GDE app 26 (e.g., for randomized initial sequences).

In some cases, an entire sequence for a round and corresponding content is sent to a corresponding user device of a group member at the start of a round and held in cache memory of the user device to facilitate low-latency navigation through options. In some embodiments, these cached sequences may be dynamically updated during a round by the GDE based on votes from other users. Before updating a sequence, in some embodiments, the GDE 12 or GDE app 26 may determine whether options to be adjusted in the sequence have already been presented to the corresponding user and, in response to previous presentation, decline to adjust the sequence, or in response to the option not yet being presented, make the adjustment. In some embodiments, the sequence is maintained server side, at the GDE 12, and the GDE app 26 (or corresponding web page) may request options (and corresponding content) consecutively, one at a time, iterating through a count, such that options may be re-sequenced server side. Maintaining the sequences server side is expected to favor lower bandwidth and simpler design in exchange for more latency in responses to user interactions and less resilience to loss of data connections.

To facilitate relatively prompt eventual consistency of sequences throughout the distributed GDE system (e.g., among program state in the user devices 14 and the GDE 12), some embodiments may store votes, options, or sequences in a real-time database, such as the real-time database offered by Firebase™ of San Francisco, Calif. In some embodiments, some or all of this data may be stored by a third party cloud-based database, e.g., in documents, like JSON or XML documents, controlled via an API of the database via requests from the various constituents of the GDE system. In some embodiments, the components of the GDE system (e.g., the GDE 12 and the GDE app 26 or corresponding webpages) may open persistent transmission control protocol (TCP) connections with such a real-time database, and the real-time database may push updates to the constituent computing devices. For instance, the real-time database may send updates reflecting changes in sequences to client devices without those client devices first sending a request for updates, e.g., a pull request for changes. The persistent TCP connection may facilitate full duplex communication with multiple exchanges, rather than opening a new TCP connection at the prompting of the client device with each new request and response. In some cases, the communication is via a WebSocket connection operative to facilitate database-side pushes of updates to the client devices.

Various efficiency measures may be implemented at the expense of increased complexity. To reduce battery consumption, in some embodiments, the client-side code (e.g., the GDE app 26 or JavaScript in a GDE-hosted webpage) may open such a connection (e.g., a persistent TCP connection, like a WebSocket) in response to the app/web page running in the foreground of the user device and close the connection in response to the app/web page running in the background more than a threshold amount of time, thereby reducing energy consumption arising from processes that listen for updates from the real-time database. To reduce bandwidth usage, some embodiments of a real-time database may send updates in the form of deltas from previously sent data, sending changes, rather than re-sending entire data structures for which only a portion changed. Upon initiation of a group decision or a round, the GDE 12 or GDE app/web pages may register with the real-time database for such updates, in some embodiments, and launch an event handler that receives updates from the real-time database. Other embodiments may use other, less responsive, techniques to favor simplicity, e.g., client side pulling of updates, like with long-polling, or thinner client applications in which sequences are hosted server side.

Individual may express their choices in a round with a number of different techniques. In some embodiments, items in a round may be presented on a mobile device screen one at a time, like in a stack, and users may input a number of different choices, depending on the embodiment. For instance, in some embodiments, users may swipe (e.g., across a graphical icon, like a photo or card, representing the item) left to vote in favor of an item and swipe right to vote against the item. This technique offers the advantage of imposing a relatively low cognitive load on the user, though other embodiments use other techniques, like on-screen buttons, or voice commands (detecting utterances of “yes,” “no,” “veto,” “don't care,” etc.) to register votes. In another example, other swipes may express other user preferences, e.g., swipe up to indicate the user does not care whether the item is chosen and down to express that the user wishes to veto the item.

Swipes may be detected and categorized with a variety of techniques. In some cases, an event handler executed by a web browser or the GDE app 26 may begin tracking a user input upon an on-touch event. For instance, in iOS™, the UISwipeGestureRecognizer class may detect swipes, or in Android™ the OnTouchListener class may be used to detect swipes. In some embodiments, swipes are detected within a webview, e.g., within an instance of a mobile web browser based on JavaScript executing in the web browser, like with the GestureDetector in an Android™ webview or with the UIKIT framework in iOS™. Some embodiments may obtain with these classes a direction of the gesture and determine whether the swipe is up, left, down, or right, for example.

In some cases, each user may be allotted a number of vetos (by which an item is removed without regard (or with less regard, e.g., by allotting a higher score to a veto) to how other's vote) or wildcards (by which an item is advanced without regard to, or with less regard to, others' votes), and a GDE app 26 instance (or the GDE 12) on the user device may increment or decrement a counter as such choices are made and compare those counters to a threshold in future veto/wildcard requests to determine if the user has remaining vetos or wildcards, preventing application of such inputs in instances in which the threshold is exceeded.

In some cases, even more expressive user interactions may be supported. For instance, angle, speed, or length of a swipe (i.e., touching and dragging while maintaining contact with a touch screen, as indicated by differences in coordinates of an on-touch event and a touch-release event on the device screen) may indicate a user's degree of conviction (e.g., swiping up to the right indicates a strong approval, down to the right a low approval, up to the left a strong disapproval, and down to the left a weak disapproval). These, or other, gestures (e.g., movement of the entire mobile device, as sensed via an accelerometer) or inputs (like selection of an input button corresponding to an up-vote or down-vote on the screen, like with a mouse-click on a webpage interface) may be converted into a user score for the item, and that item may be reported by the user's instance of the GDE app 26 to the GDE 12 as a vote. In some cases, decisions may cause a notification to appear on a wearable user device, like a smartwatch, and upon selection, the notification may cause a swipeable interface to be presented on the wearable, such that users may vote by swiping in the described fashion without pulling their phone out of their pocket. In such examples, votes may be conveyed by BlueTooth™ from the wearable to a smartphone and via cellular signals to the Internet 16. Scores may be binary (yes or no) or more granular (0 to 5) and cardinal or ordinal, in some cases, depending on the user expressions supported. More expressive votes are expected to yield group decisions with higher aggregate utility at the expense of increased cognitive load upon users.

As each user's vote is received in a round, the GDE 12 may take a number of steps. First, in response, in some embodiments, the GDE 12 may determine whether to terminate the round without waiting for further user input. Some embodiments may stop a round when every user has selected (e.g., voted in favor of) the same option. Other embodiments may continue a round until every user has selected at least a threshold number of options, providing for a more diverse set of options going forward at the expense of additional user input. Or some embodiments may wait until every user has made a decision regarding every option in a round or until a threshold amount of time allotted to a round has expired. A variety of different round-decision criteria may be compared to the current state of user decisions. Further, in some embodiments, the GDE 12 may send an indication of the new scores to other instances of the GDE app 26 for other members of the group, and those instances of the GDE app 26 may adjust the order in which subsequent items are presented.

Depending upon the embodiment, and tradeoffs between speed/cognitive load/and fidelity to user preferences, a number of different determinations may be made by the GDE 12 to ascertain whether members of a group have collectively chosen an option (e.g., a category or item at a leaf node) in a given round. In some embodiments, an option may be deemed chosen in response to more than a threshold amount of the group voting in favor of the option, or the option obtaining a threshold score based on votes, and a round may be deemed complete when a threshold amount of options are chosen, e.g., one. Such an approach favors a satisficing strategy, rather than an optimizing strategy, to expedite decisions and allow rounds to end without every group member voting on every option in that round. In some cases employing an optimizing strategy, the option that received the highest average score or was selected by the most users may be deemed the group's choice in a round. In some cases, when summing votes with the GDE 12 to calculate scores for options, votes for an option may count as a plus one, votes against as a minus one, do-not-care votes as a zero, wildcard votes as a plus ten, and veto votes as a minus ten (or other suitable value for wildcards and vetos depending upon the desired strength of these votes, like a percentage of the number of members in the group, or the number of members minus one). In another example, the top two (or some other threshold amount) highest scoring items (e.g., determined by summing the scores for all of the items in a round, or by calculating some measure of central tendency, like a mean, mode, or median) may be deemed chosen. In another example, items may first be culled according to user vetos and advanced according to wildcards before scores are used to ascertain whether remaining items are to be advanced. When a round is complete, the GDE 12 may signal the GDE app 26 instances of members of the group to indicate that the users need not continue making selections in that round and, in some cases, to indicate the group's choice for the round. In some embodiments, users may be presented with an interface by which they may “dig out,” as described above, more specific items from un-chosen categories in a round at this stage, and those items may be carried forward to later rounds, notwithstanding de-selection of their branch of the taxonomy.

After a decision is made in a round, some embodiments may select from a taxonomy those branches that prevailed in the decision (and any individual items “dug out”). For instance, in the example above, assuming users chose Italian restaurants, the next round may present as options pizza, Sicilian, and Neapolitan sub-categories of Italian restaurants. And assuming in the next round users chose pizza, the next round may present leaf node items as options: “Benny's Pizza Parlor” and “Downtown Pizza.” This example, in the interest of being concise, underplays the advantages of some embodiments due to the small set of options, but the present techniques are applicable to much larger datasets, in which groups quickly drill down into specific sub-sub-categories of options among hundreds or thousands of candidates, with some measure of group consensus being reached at each step. In some cases, the scores of the final leaf nodes may be presented to the group leader to make the ultimate decision in view of the stated preferences of group members. In some embodiments, only the group leader (who initiated the decision making process and added members to the group initially) is shown the final scores (to avoid offending members of the group when the leader overrides a choice, e.g., to accommodate food allergy of a group member), or in some cases, each member of the group is shown the final scores for the leaf nodes to view the final group decision.

In some cases, the group leader selects or approves a final selection, and a number of different steps may be taken in response. In some cases, a calendar event is added to a calendar of each member of the group (or an invite is sent that, when selected, causes the event to be added). In some cases, the user may be presented with the option to further plan execution of the choice, e.g., with a link to a webpage to purchase a chosen product, or a link to another service to facilitate an event, such as a user interface element that, when selected, launches a pre-populated ride-sharing app ride request interface (e.g., with the time and destination already populated based on the group selection) or a restaurant reservation app interface (e.g., with the time, group size, and restaurant fields already populated based on the group selection). Some embodiments may determine which services are implicated by a group selection or the type of decision being made and compose one or more API requests, e.g., uniform resource identifiers with parameters that convey to a corresponding API server context of the group decision, like date, choice, geolocation, group members, etc.

In some embodiments, the GDE 12 or GDE app 26 may select among APIs for, and compose requests for the following: a request for an offer associated with an item selected by the group (like a URL for a product page on Amazon™); a request to add an event to a calendar of a member of the group (like an insert event request on the Google Calendar™ API); a request to view a route to a geolocation where an item selected by the group is located (like a request to the MapQuest™ Directions API for a geolocation of the user); a request to reserve or view available capacity at or of an item selected by the group (like a request to one of the unofficial OpenTable™ APIs for a reservation URL); a request to establish an online group fund for paying for an item selected by the group (like a request to the Tilt™ API to establish a crowdfunding project); a request to obtain transportation to an item selected by the group (like a request to the Uber™ API for a ride from a user's current geolocation to a geolocation of an item chosen by the group); or a request to view weather forecasted for the a geolocation of an item selected by the group (like a request to the Weather API of WeatherUnderground™). In another example, embodiments may compose an API call to a obtain delivery of an item chosen by the group, e.g., with the Postmates™ Delivery API. In some cases, when registering to create user accounts with the GDE 12, users may be afforded the opportunity to provide access to the GDE 12 to corresponding user accounts with these other services, e.g., with OAuth authentication.

In some cases, group members may be presented with offers (deals, coupons, two-for-one-deals, etc.) at various stages of the decision making process. In some cases, when viewing leaf nodes in a final round, those leaf nodes may be presented with a indication of whether a corresponding offer is available (e.g., 20% off at a given restaurant) to sway members of the group to a particular choice. Or some embodiments may sequence options to uprank options for which offers are available. In some cases, embodiments of the GDE 12 may track 1) which offers are presented, and 2) whether users chose an item associated with an offer to seek reimbursement from a business associated with the chosen item. In some cases, offers may be associated with publisher-specific offer codes or a single-use codes that a business may correlate with the entity providing the GDE app 26 to provide compensation. In some embodiments, offers may be obtained via the affiliate network system (with the GDE 12 operating as a publisher) described in U.S. patent applicant Ser. No. 14/489,875, titled “Tracking Offers Across Multiple Channels,” filed 18 Sep. 2014, the entire contents of which are hereby incorporated by reference for all purposes. Similarly, some embodiments may select advertisements based on user behavior observed by the GDE 12, and those advertisements may be displayed to the corresponding users, e.g., in the GDE app 26 or in other contexts.

In the examples above, rounds are described as traversing levels of a taxonomy, from a high-level of abstraction to specific, granular levels at leaf nodes associated with choices. Alternatively, or additionally, other embodiments may use other data models. For instance, some embodiments may organize options in an ontology that is not necessarily a tree data structure, or that contains multiple tree structures. For instance, some embodiments may associate items with attributes, or facets, which may be shared by multiple items, but are not necessarily hierarchical, e.g., gifts both in the category of men's boots and available for sale in downtown Austin, Tex. Some embodiments may support presentation of options based on a faceted search of the ontology, e.g., presenting bars that have the attribute of either being a pub or not being a pub, and then presenting bars that have the attribute of either being downtown or uptown, which is not a sub-category exclusive to pubs or non-pubs. In some cases, to expedite search of an ontology, attributes may be presented in a sequence of rounds (e.g., with one attribute in a round, or permutations of combinations of two or more attributes in a round, like when a cardinality of the attributes is less than a threshold) based on the distinguishing power of attributes. The distinguishing power of facets may be gauged with a variety of techniques, including making a determination at the GDE 12 to select as the next attribute for a round an attribute with the closest to 50% applicability to remaining candidates, favoring attributes that divide the remaining candidate options into near halves, rather than attributes that merely carve out a small subset, like attributes that distinguish only 5% from 95% of the remaining candidate items. In some cases, attributes may be ranked and sequenced according to a score based on their cardinality and variance of item count among attribute values to favor attributes with low cardinality and low variance. In some cases, this ranking may be updated after each round based on the remaining candidates.

Because users are expected to interact with the GDE system frequently, high latency in system responses to user requests (e.g., more than 2 seconds) is expected to negatively affect the user experience. Some embodiments may use a variety of techniques to reduce latency. For example, some embodiments may cache candidate items and associated content (e.g., images, video, audio) on user devices 14 in advance of a user engaging with those items, so that as a user moves through a stack of candidate items, the next item may be presented in a responsive fashion, with relatively little delay. In another example, user histories may be pre-processed and stored for fast retrieval, e.g., in a key-value pairs with keys based on user identifiers, group identifiers, or the like. Other embodiments, though, may operate at higher latency, e.g., to favor simpler system design.

Because some users may not have the GDE app 26 installed on their computing device when participating in group decisions, some embodiments may provide a web interface, e.g., a mobile website that may facilitate the interactions described herein in a web browser, while inviting the user to install the app for a better experience. In these examples, JavaScript™ may dynamically adjust elements of a document object model based on communications with the GDE 12 like those described above and report user votes to the GDE 12.

Because some users are slow to make decisions, some embodiments may apply a decision timer to games or rounds, and users who do not make choices within the allotted time may forfeit their ability to contribute to a decision in a round or game. In some cases, a group leader may specify a time for a game or rounds when initiating a group decision making process. In some embodiments, allotted time may be adjusted based on a number of options in a round or based on user engagement, e.g., in response to no users making a choice within a threshold duration of time, a timer may be advanced to expedite a round at the decision and instruction of the GDE 12, so users who are not engaged do not slow down the process for others.

Some embodiments may log user selections for use in making recommendations and initializing lists of options to be presented in later decisions. In some cases, each user may be associated with a user history, each user history having a plurality of group records (a group being defined by its members, e.g., being uniquely identified by a hash of sorted user identifiers of members), and each group record having a plurality of group decisions. Each group decision in the user history, in some embodiments, may be associated with an identifier unique to that group and that decision, and the group session may include the items presented to the respective user and the user's choices, each of which may be time stamped and, in some cases, associated with a geolocation related to the decision, like that provided by the group leader, or the user's current geolocation. Thus, some embodiments may maintain a record of the user's preferences in the context of 1) a category of decision, like restaurants, bars, purchases, etc; 2) a group of other users; 3) a time; and 4) a geolocation. Based on this data, some embodiments may detect patterns, e.g., by converting the user history into a lower dimensional vector and clustering the vectors. Or by performing a stochastic gradient descent to train various models on the user histories to predict user selections in subsequent games or rounds, including selections of offers that may be presented. Resulting clusters or other models may be used to predict subsequent user choices and pre-sort and pre-rank items presented to the user, such that items the user is likely to favor are presented earlier, thereby potentially reducing the time to decision in embodiment pursuing a satisficing strategy. Further, such clusters or models may be used to select offers or advertisements to present the user.

In another example, recommendations, list initialization, and offer or ad presentation may be based on responses by past, similar groups relative to the group at issue. For example, if in the past, group A wanted Italian food, included a vegetarian, and chose restaurant X, embodiments may construct a predictive model that learns from this decision and later, when group B similarly wants Italian and includes a vegetarian, then the GDE may input these attributes into such a model, which may respond by suggesting restaurant X as a restaurant candidate over other restaurant candidates, e.g., by calculating a score for restaurant X that favors that restaurant. In some cases, users' profiles may be populated based on inferences from group decisions or based on information explicitly provided by users, e.g., during account creation. Past groups in logs may be scored according to similarity with the group at issue based on the number of group members with matching attributes in such profiles (e.g., drinker/non-drinker, attends with children/no-children, vegetarian, vegan, gluten-free, etc.). In some cases, those attributes may be scored and weighted according to their predictive power regarding group agreement in logged group decisions (e.g., periodically as a batch process), and the weights may be applied (e.g., at decision time) to comparisons of the group at issue with previous groups to score group similarity (e.g., if vegan is highly predictive of selecting a the same restaurant among groups in the same geographic area, then the attribute of vegan may be upweighted). Based on the scores of group similarity, in some embodiments, options chosen by previous groups (e.g., in the same type of group decision) may be scored (with an option score) based on the number of similar groups that selected those items, with each similar group's contribution to the option score weighted by that respective group's similarity score. In some cases, similar groups are downweighted based on distance between the geolocation of the group decision at issue and the geolocation of the earlier group. The resulting option scores may be used to make recommendations, initialize lists of options, and select offers or ads for presentation.

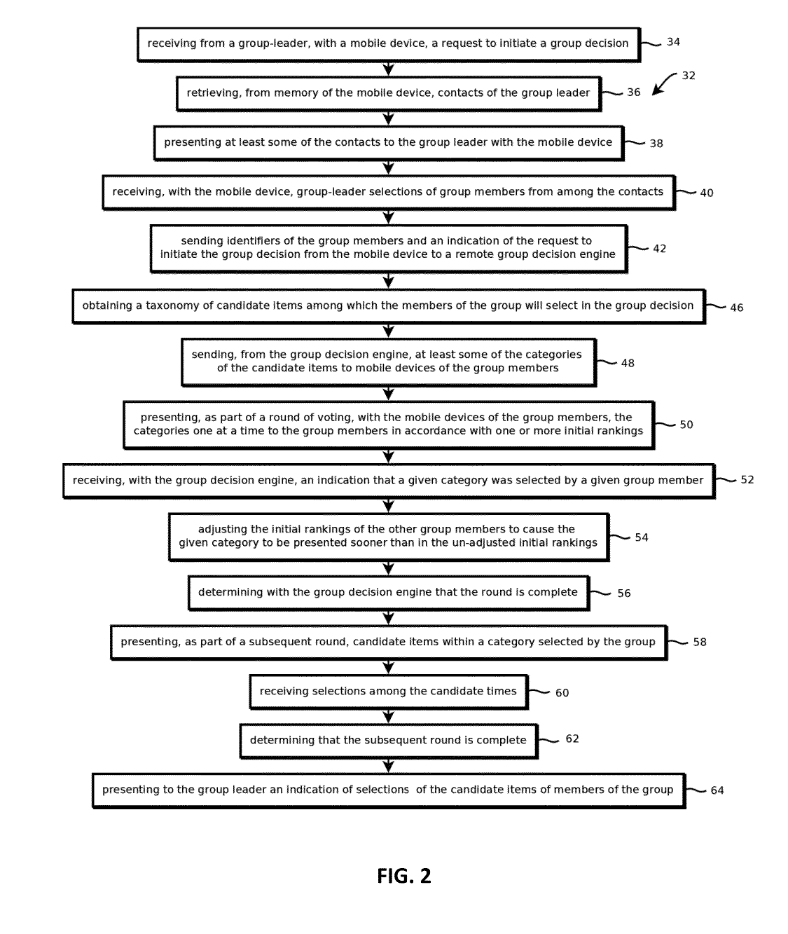

FIG. 2 shows an example of a process for making a group decision 32. In some embodiments, the process 32 may be performed by the components of FIG. 1, but embodiments are not limited to that implementation. In this example, the process 32 includes receiving from a group leader, with a mobile device, a request to initiate a group decision, as indicated by block 34. The process 32 may further include retrieving, from memory of the mobile device, contacts of the group leader, as indicated by block 36. Some embodiments may include presenting at least some of the contacts to the group leader with the mobile device, as indicated by block 38, and receiving, with the mobile device, group leader selections of group members from among the contacts, as indicated by block 40. Some embodiments may include sending identifiers of the group members and an indication of the request to initiate the group decision from the mobile device to a remote group decision engine, as indicated by block 42. Some embodiments may include obtaining a taxonomy of candidate items among which the members of the group will select in the group decision, as indicated by block 46. Obtaining the taxonomy may include querying a taxonomy for a particular hierarchical level, such that selected options within that hierarchical level may be queried for subcategories. The process 32 may further include sending, from the group decision engine, at least some of the categories of the candidate items to mobile devices of the group members, as indicated by block 48. Some embodiments may include presenting, as part of a round of voting, with the mobile devices of the group members, the categories one at a time to the group members in accordance with one or more initial rankings, as indicated by block 50. Some embodiments may also include receiving, with the group decision engine, an indication that a given category was selected by a given group member, as indicated by block 52. Some embodiments may include adjusting the initial ranking of the other group members to cause the given category to be presented sooner than in the un-adjusted initial rankings, as indicated by block 54. In some cases, embodiments include determining with the group decision engine that the round is complete, as indicated by block 56, and presenting, as part of a subsequent round, candidate items within a category selected by the group, as indicated by block 58. Some embodiments may include receiving selections among the candidate items, as indicated by block 60, and determining that the subsequent round is complete, as indicated by block 62. Some embodiments may include presenting to the group leader an indication of selections of the candidate items of group members, as indicated by 64.

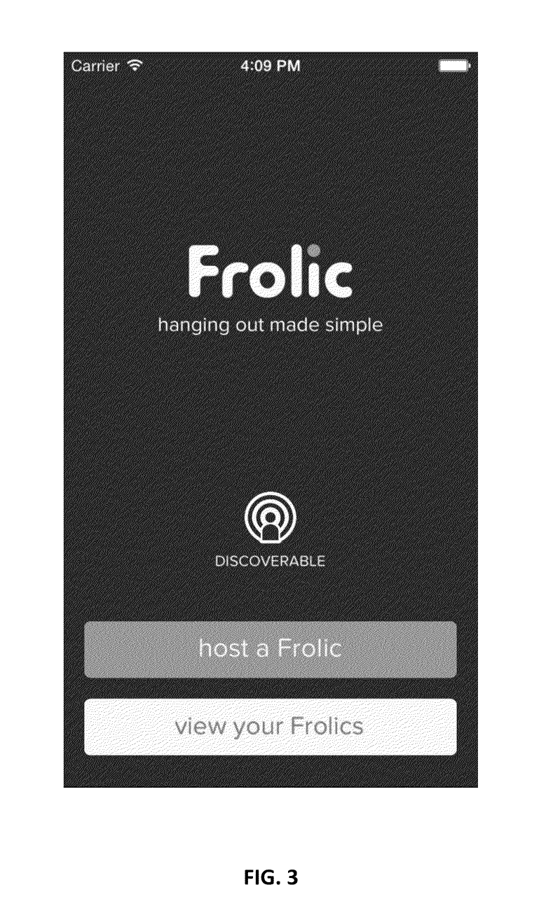

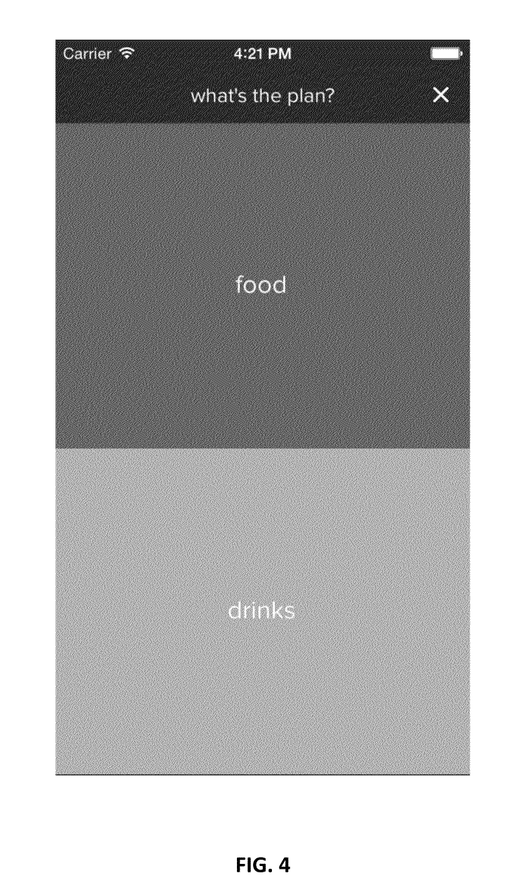

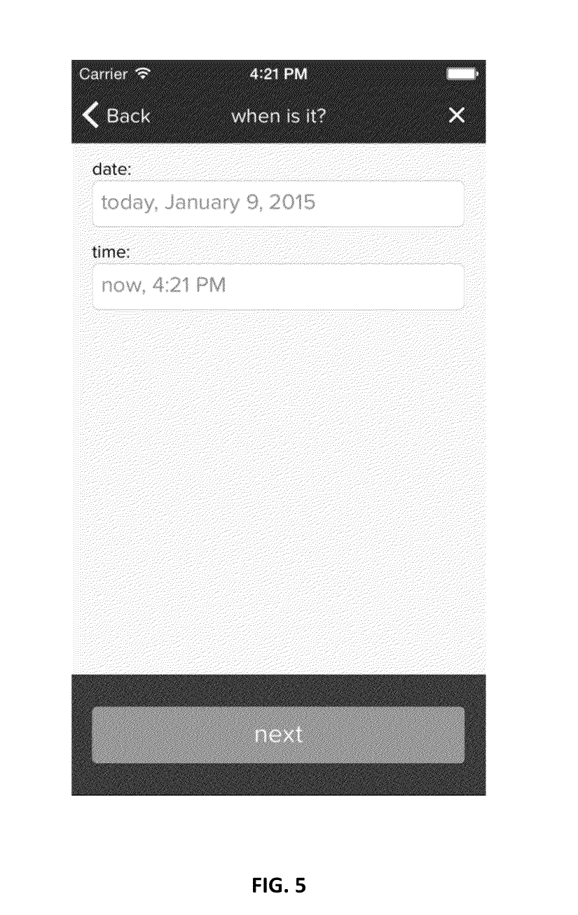

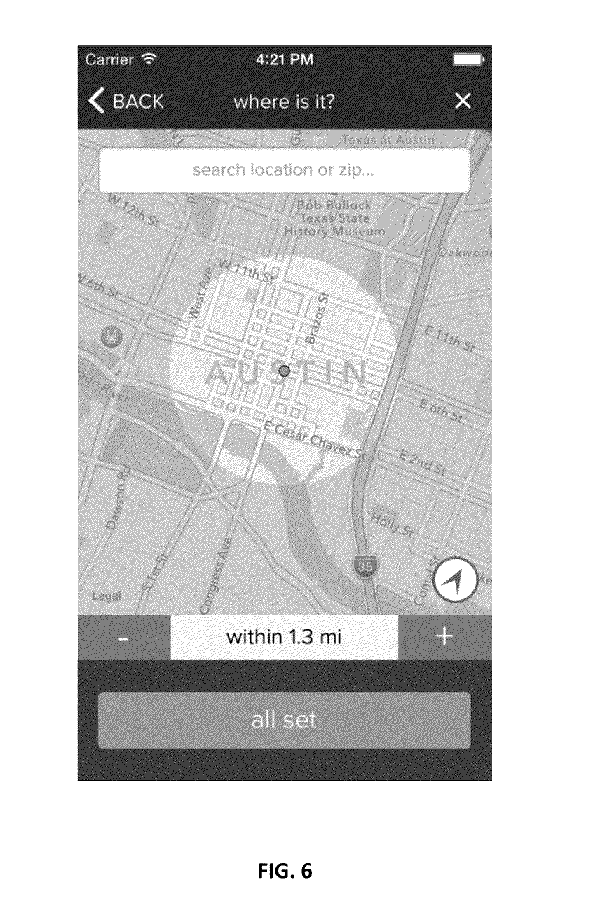

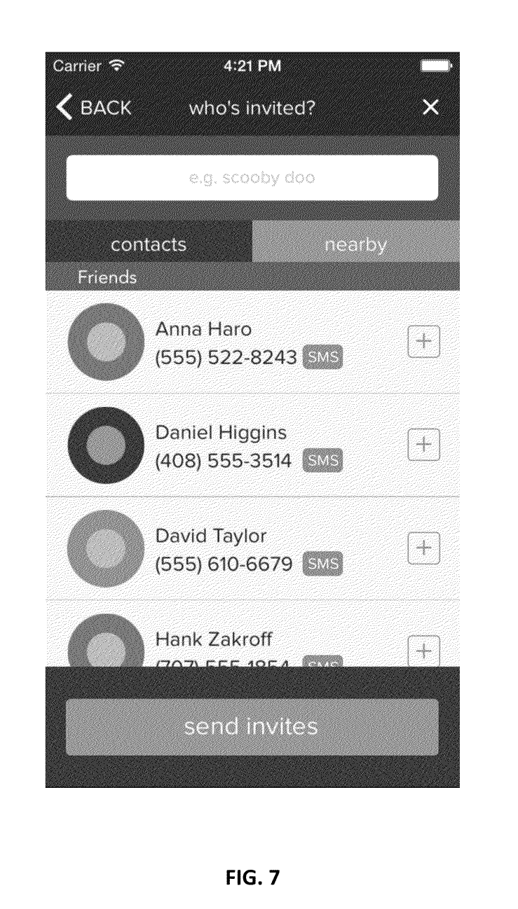

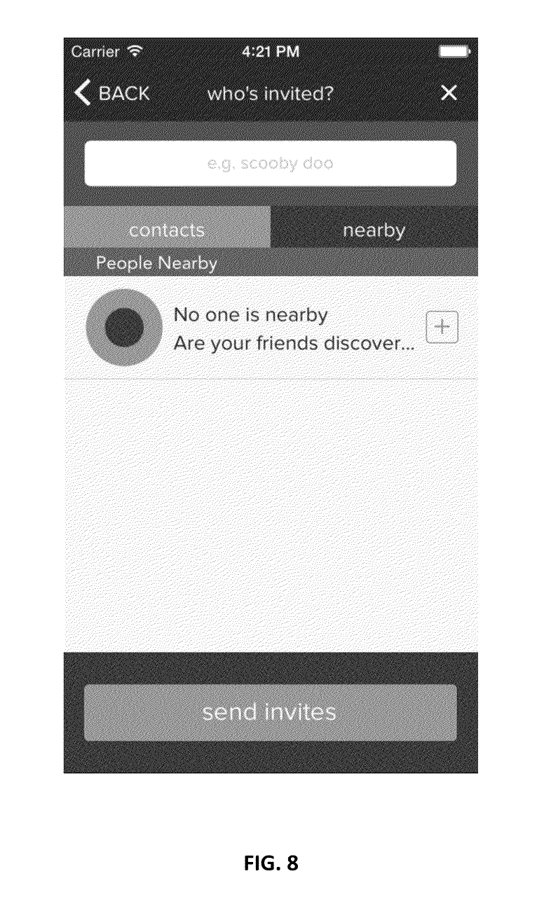

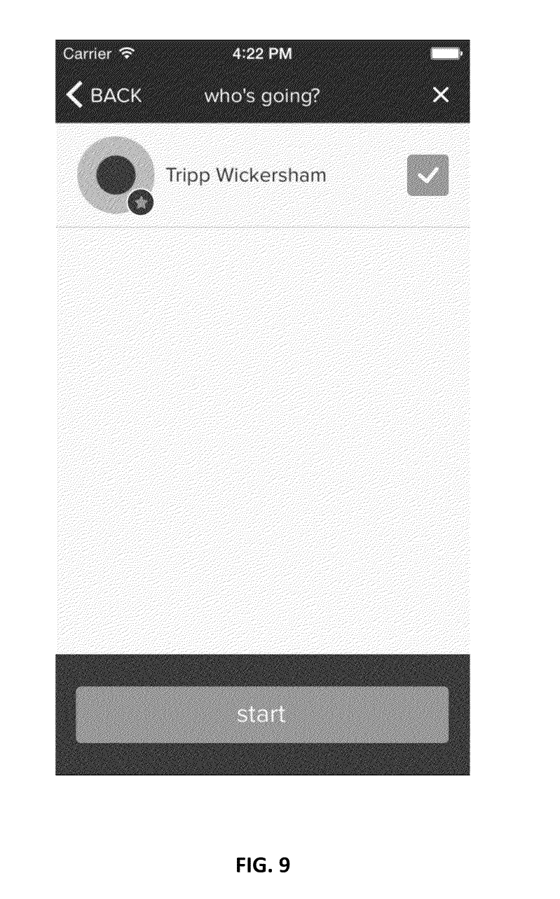

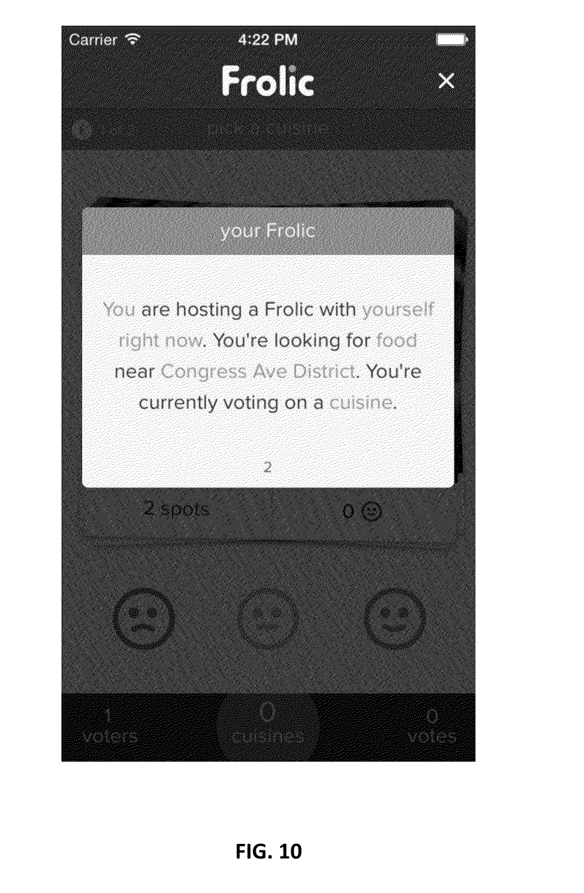

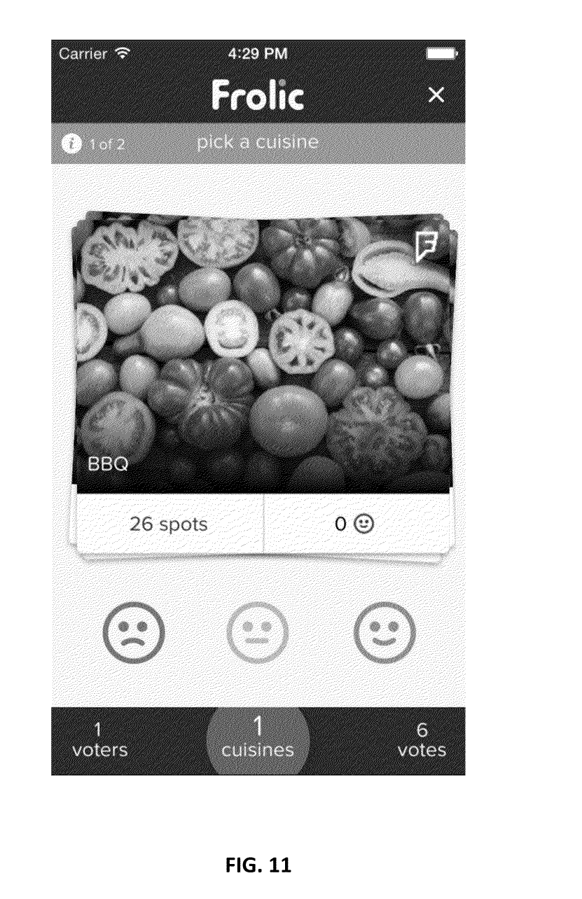

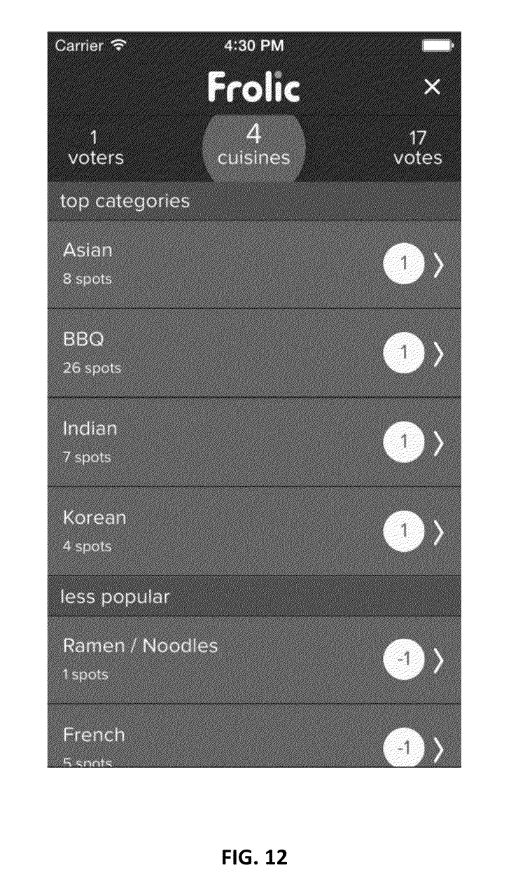

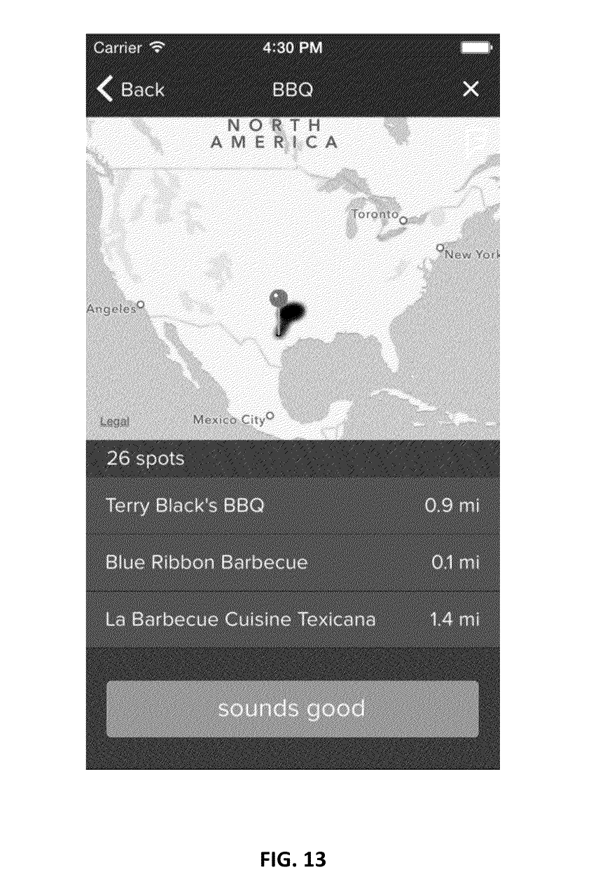

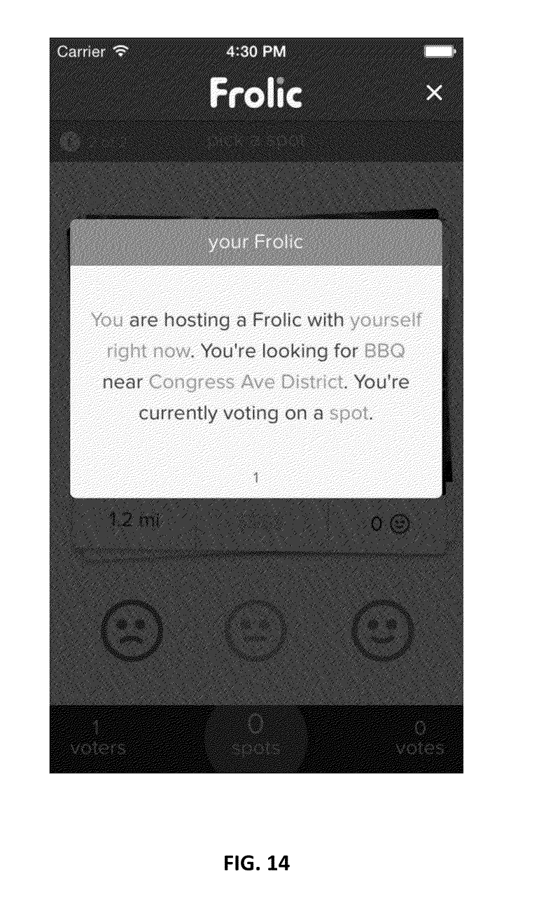

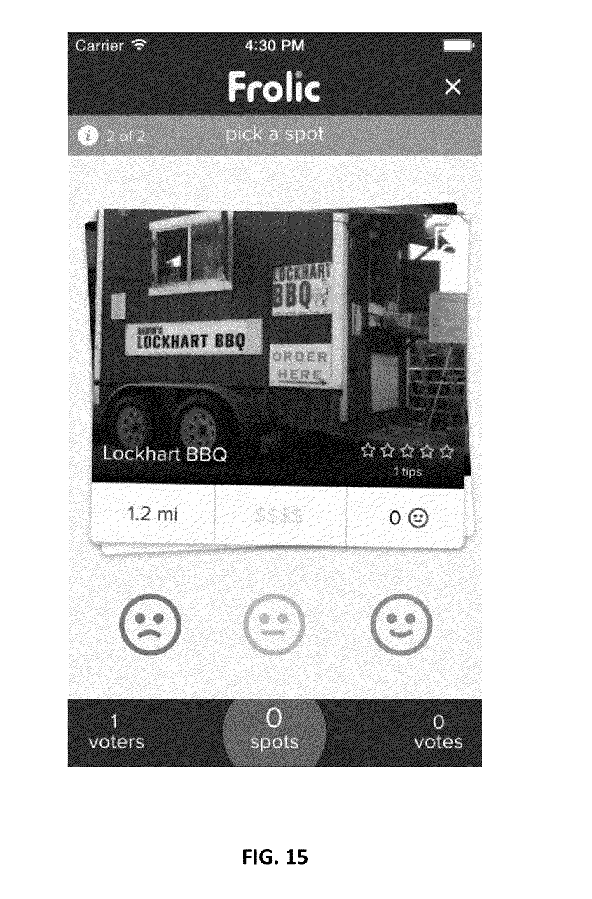

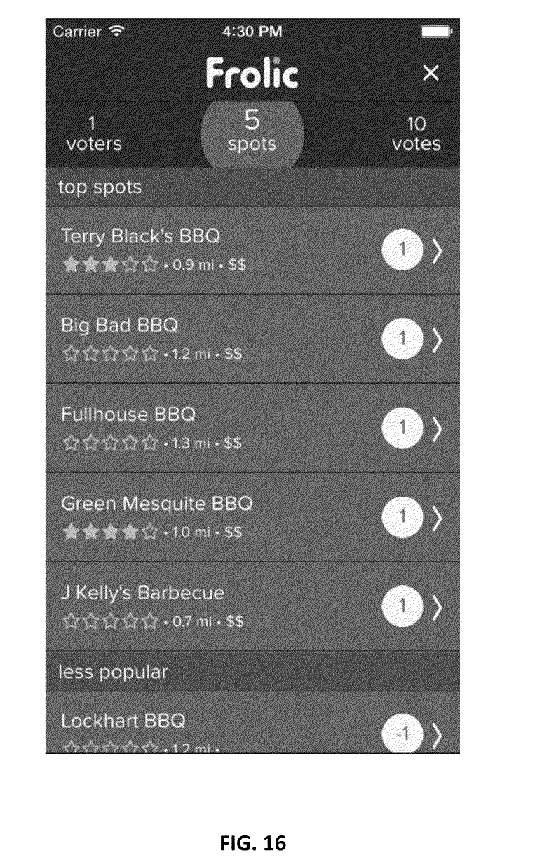

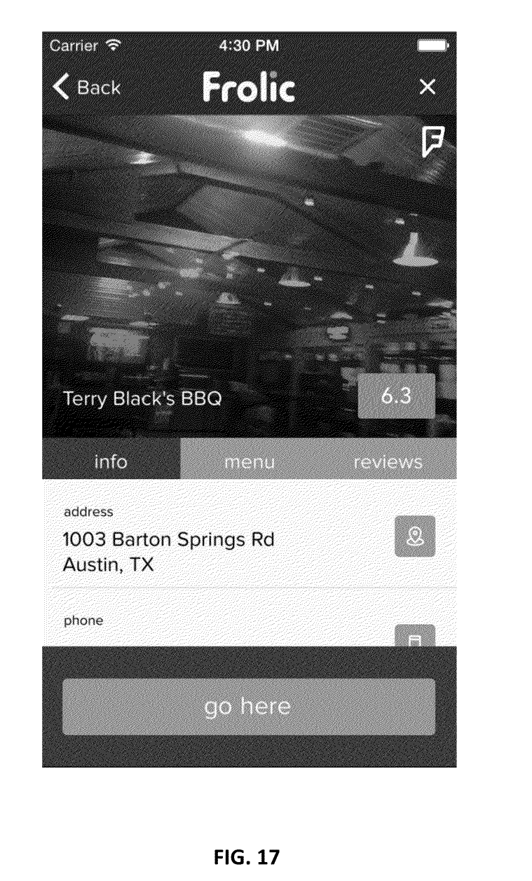

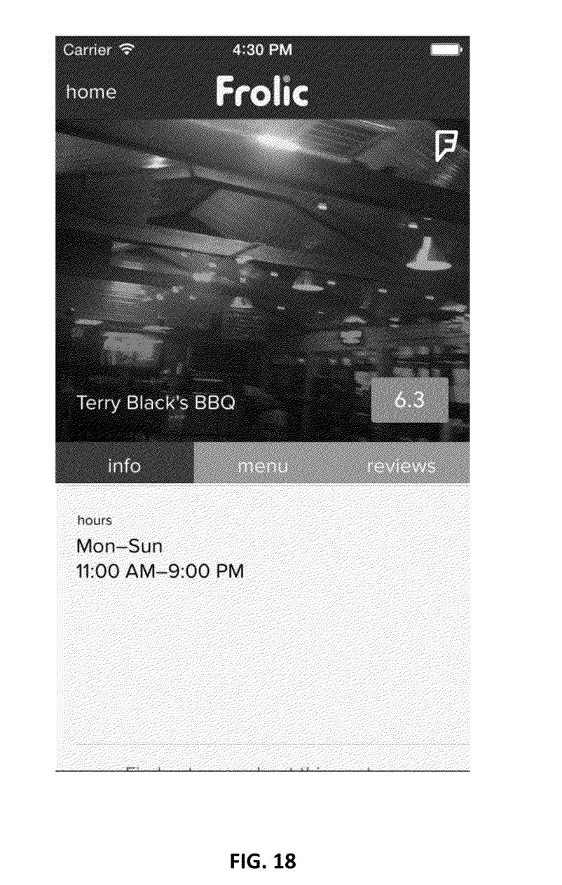

FIGS. 3-18 illustrate example user interfaces of a group-decision engine native application, e.g., some instances of the GDE app 26 of FIG. 1. The interfaces are presented generally in the sequence that a user would experience when initiating and participating in a group decision, in some embodiments. FIG. 3 shows an example user interface by which a user indicates that they wish to initiate a new group decision, called a “frolic” in this example, or view existing group decisions among which they are participants. FIG. 4 shows an example user interface by which a group leader specifies a category of decision by touching one of two decision categories, food and drink. FIGS. 5 and 6 show example user interfaces by which a group leader may specify a date, time, and location (e.g., counterpoint and threshold distance for permissible items) for the group decision. FIG. 7 shows an example user interface indicating contacts in the group leader's contact list and by which users may be invited to join the group by touching icons for corresponding users. FIG. 8 shows an example user interface indicating which contacts of a user (or other users of the app) are geolocated nearby (e.g., within a threshold distance to the group leader) and by which users may be invited to join the group. FIG. 9 shows an example user interface indicating which users are in a group that will make a decision. FIG. 10 shows an example user interface indicating a group decision is being initiated to select a restaurant by first voting on cuisine. FIG. 11 shows an example user interface indicating categories of restaurants among which users may vote in a group decision. In this example, a user may swipe across the card depicted as described above to register a vote or may select one of the face icons to register a vote, e.g., touching the frowning icon to vote against the item depicted in the top card, the neutral-faced icon to indicate low conviction, and the smiling icon to vote in favor of the item. After each vote, in some embodiments, the top card corresponding to an option may be shown to move off the UI in an animated fashion, e.g., in a direction corresponding to the vote, and a next option in the sequence of options may be presented. FIG. 12 shows an example user interface by which the group leader may view votes for each category. FIG. 13 shows an example user interface indicating a category in which the group has elected to choose an item, with an input labeled “sounds good” by which a group leader may confirm the decision. FIG. 14 shows an example user interface indicating the status of the group decision after the first round. FIG. 15 shows an example of an interface by which a user may vote on an individual BBQ restaurant item using inputs like those of FIG. 11. FIG. 16 shows an example of an interface by which the group leader may view votes for each item. FIG. 17 shows an example user interface by which the group leader may validate the group's decision by selecting the input labeled “go here.” FIG. 18 shows an example user interface by which information about the group's chosen item is viewed.

FIG. 19 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A method of expediting a group decision, the method comprising: instructing computing devices of group members to present options for voting by group members in a plurality of rounds, each round presenting options at a corresponding hierarchical level of a taxonomy, and each round after a first round excluding at least some options based on a group selection in an earlier round; receiving votes of at least some group members in at least some rounds and, in response: adjusting sequences with which options are presented to cause options voted upon favorably by at least some group members to appear earlier in the respective round for other group members; and determining whether a sufficient amount of votes for an option have been received to designate the respective round as complete; and informing a group member of a decision by the group.
2. A method, comprising: receiving, from a group leader's computing device, a request to initiate a group decision and one or more identifiers of members of a group requested to collectively help make the group decision; obtaining a category of decision, the category of decision indicating the category of items among which the group is to choose; obtaining candidate sub-categories within the category of decision; sending computing devices of members of the group at least some of the candidate sub-categories to choose among; receiving sub-category votes on at least some of the candidate sub-categories from at least some of the computing devices of the members of the group; based on the sub-category votes, selecting a sub-category from among the candidate sub-categories; sending the computing devices of members of the group candidate items within the selected sub-category, without sending at least some items in un-selected sub-categories; receiving item votes on at least some of the candidate items from at least some of the computing devices of the members of the group; and sending the group leader a group decision based on the item votes, wherein the decision is determined before all of the group members have voted on all of the items.
3. The method of embodiment 2, wherein: the request to initiate a group decision is received by a group decision engine over the Internet; the request is received with a geolocation specified by the group leader, the geolocation being specified by the computing device of the group leader sensing the geolocation or by the group leader explicitly entering the geolocation; the group leader's computing device comprises a mobile computing device, the group leader being a group leader in virtue of sending the request to initiate the group decision; the request to initiate a group decision is received separately from and before the one or more identifiers of members of the group; the one or more identifiers of the members of the group include contact information for each member of the group retrieved from a set of contacts stored in memory of the mobile computing device of the group leader; the group comprises four or more people, each having a different computing device through which the respective group member participates in the decision; the category of decision includes restaurants and the group decision comprises choosing a restaurant from among more than 80 candidate restaurants based on choices made by each member of the group; the sub-categories include sub-categories of restaurants, including varieties of cuisine; the items include restaurants within the sub-categories of restaurants; obtaining a category of decision comprises receiving, from the group leader's computing device, an indication of a selection by the group leader of a category from among categories including at least three of the following categories: restaurants, bars, events, gifts, destinations, lodging, flights, movies, video games, and television shows; sending computing devices of members of the group candidate sub-categories comprises; determining that the obtained category of decision relates to restaurants and, in response, selecting an application program interface (API) of a restaurant listing from among a plurality of different APIs for different categories of group decisions; and sending an API request for restaurants to the restaurant listing, the API request requesting restaurants within a threshold distance to the geolocation of the group leader; receiving a taxonomy of restaurants from the restaurant listing, the taxonomy including the sub-categories of restaurants and the restaurants within each sub-category of restaurant; determining a plurality of different sequences with which the sub-categories are to be presented for voting on the computing devices of the group members, the sequences indicating an order in which the sub-categories are to be presented one at a time, one after another; and sending at least part of the respective sequences and the sub-categories of restaurants to the computing devices of the group members; selecting a sub-category comprises at least one of the following: determining that a majority of the members of the group voted for the selected sub-category; determining that the group leader chose the selected sub-category in view of the sub-category of votes; or determining that more than a threshold amount of members of the group voted for the selected sub-category; the sub-category votes include choices including at least three of the following: an indication that the group member does not care whether a respective sub-category is chosen, an indication that the group member vetoes a respective sub-category, a vote in favor of a respective sub-category, and a vote against a respective sub-category; receiving sub-category votes on the sub-categories comprises: receiving a given sub-category vote from a given group member on a given sub-category; sending instructions to the computing devices of the other group members to change the respective sequences with which the sub-categories are presented for voting such that a vote against the given sub-category causes the given sub-category to be presented later in the respective sequence or a vote in favor of the given sub-category causes the given sub-category to be presented earlier in the respective sequence; sending the group leader a group decision based on the item votes comprises; tallying the item votes; sending the group leader the group decision; and receiving from the group leader a choice either consistent with or different from the group decision; and the steps of claim 1 are performed in the order recited.
4. The method of any of embodiments 2-3, wherein the category of decision is: obtained from the group leader's computing device; and indicates a selection by the group leader of a category from among categories including at least two of the following categories: restaurants, bars, events, gifts, destinations, lodging, flights, movies, video games, and television shows.
5. The method of any of embodiments 2-4, comprising: before sending the sub-categories, determining a plurality of different sequences to present at least part of the sub-categories for different group members, such that different group members vote on at least some of the sub-categories in a different order; and sending at least part of the sequence selected for each respective group member to the respective group member's computing device, sending at least part of the sequence including sending sub-categories according to the sequence in response to sub-category votes or sending the entire sequence before sub-category votes are received.
6. The method of any of embodiments 2-5, comprising: determining a sequence to present the sub-categories or the items to at least some of the group members based on logged votes by a given group member in past group decisions including the same group members.
7. The method of embodiment 6, wherein determining the sequence to present the sub-categories or the items comprises determining the sequence based on a correspondence with times at which the past group decisions were made.
8. The method of any of embodiments 2-7, comprising: during a round of voting, adjusting a sequence with which the sub-categories or items are presented to a first group member from among the group members in response to a vote during the round of voting by a second group member from among the group members.
9. The method of embodiment 8, wherein adjusting the sequence comprises determining that an item or a sub-category subject to the vote by the second group member has not yet been presented to the first group member, and wherein the adjustment either: causes an item or a sub-category the second group member voted in favor of to be presented earlier in the sequence to the first group member; or causes an item or a sub-category the second group member voted against to be presented later in the sequence to the first group member.
10. The method of embodiment 9, wherein the first group member and the second group member are sent different items in a different sequence, and wherein the adjustment is made with a real-time database configured to synchronize application data across distributed clients.
11. The method of any of embodiments 2-10, comprising: before sending the candidate items and after selecting the sub-category, sending a plurality of candidate sub-sub-categories within the selected sub-category to the computing devices of members of the group; and receiving sub-sub-category votes on at least some of the candidate sub-sub-categories from at least some of the members of the group, wherein sending the computing devices of members of the group candidate items within the selected sub-category comprises: based on the sub-sub-category votes, selecting a sub-sub-category from among the candidate sub-sub-categories; and sending the computing devices of members of the group one or more sets of candidate items within the selected sub-sub-category, without sending at least some candidate items within un-selected sub-sub-categories.
12. The method of any of embodiments 2-11, wherein the decision is determined without all group members voting on all sub-categories.
13. The method of any of embodiments 2-12, comprising: determining the group decision in response to receiving more than a threshold amount of item-votes in favor of a given item without waiting for all group members to vote on all of the items.
14. The method of embodiment 13, wherein: the sub-category is selected in response to receiving more than a threshold amount of item-votes in favor of a given sub-category without waiting for all group members to vote on all of the sub-categories.
15. The method of any of embodiments 2-14, comprising: determining that a threshold duration of time has elapsed since sending the candidate sub-categories; and in response to determining that the threshold duration of time has elapsed, selecting the sub-category based on sub-category votes received without waiting for group consensus.
16. The method of embodiment 15, wherein the threshold duration is determined based on an amount of time elapsed since a sub-category vote was last received.
17. The method of any of embodiments 2-16, comprising: maintaining a persistent transmission control protocol (TCP) connection with a given computing device among the computing devices of the group members; and pushing an update to a sequence with which items are to be presented for voting to the given computing device via the persistent TCP connection without waiting for a pull-request from the given computing device.
18. The method of embodiment 17, wherein the persistent TCP connection is established and maintained responsive to a native application executing in the foreground of the given computing device.
19. The method of any of embodiments 17-18, wherein sending the update comprises sending a difference between a previously sent sequence and a new sequence without sending a complete copy of the new sequence.
20. The method of any of embodiments 2-19, comprising: composing an application program interface (API) request based on the group decision; and sending the API request to a service that fulfils at least part of a choice of the group decision.
21. The method of embodiment 20, wherein the API request includes at least one of the following: a request for an offer associated with the item selected by the group; a request to add an event to a calendar of a member of the group based on a date indicated by the group decision or by the request to initiate the group decision; a request for a route to a geolocation where the item selected by the group is located; a request to reserve or view available capacity at or of the item selected by the group; a request to establish an online group fund for paying for the item selected by the group; a request to obtain transportation to the item selected by the group; or a request to view weather forecasted for the geolocation of the item selected by the group.
22. The method of embodiment 2, comprising: selecting an advertisement or an offer based on at least some of the item votes or the sub-category votes; and causing the selected advertisement or offer to be sent to at least some of the members of the group.
23. A method, comprising: receiving from a group-leader, with a mobile device, a request to initiate a group decision; in response to the request to initiate a group decision, retrieving, from memory of the mobile device, contacts of the group leader; presenting at least some of the contacts to the group leader with the mobile device; receiving, with the mobile device, group-leader selections of group members from among the contacts; sending identifiers of the group members and an indication of the request to initiate the group decision from the mobile device to a remote group decision engine; sending, with the group decision engine, to the group members an invitation to participate in the group decision; requesting, with the group decision engine, from a remote service, a taxonomy of candidate items among which the members of the group will select in the group decision, the taxonomy specifying the candidate items and categories of the candidate items; sending, from the group decision engine, at least some of the categories of the candidate items to mobile devices of the group members; presenting, as part of a round of voting, with the mobile devices of the group members, the categories one at a time to the group members in accordance with one or more initial rankings; receiving, with the group decision engine, an indication that a given category was selected by a given group member; adjusting the initial rankings of the other group members to cause the given category to be presented sooner than in the un-adjusted initial rankings; determining with the group decision engine that the round is complete; presenting, as part of a subsequent round, candidate items within a category selected by the group and not presenting at least some candidate items within a category not selected by the group; receiving selections among the candidate times; determining that the subsequent round is complete; and presenting to the group leader an indication of selections of the candidate items of members of the group.
24. A tangible, non-transitory, machine-readable medium storing instructions that when executed by a data processing apparatus cause the data processing apparatus to perform operations comprising: the method of any of embodiments 1-23.
25. A system, comprising: one or more processors; and memory storing instructions that when executed by the processors cause the processors to effectuate operations comprising: the method of any of embodiments 1-23.

What is claimed is:

1. A method of expediting a group decision, the method comprising:
instructing, with one or more processors, remote computing devices of group members to present options for voting by group members in a plurality of rounds, each round presenting options at a corresponding hierarchical level of a taxonomy, and each round after a first round excluding at least some options based on a group selection in an earlier round;
receiving votes of at least some group members in at least some rounds and, in response:
adjusting, with one or more processors, sequences with which options are presented to cause options voted upon favorably by at least some group members to appear earlier in the respective round for other group members; and
determining, with one or more processors, whether a sufficient amount of votes for an option have been received to designate the respective round as complete; and
informing a group member of a decision by the group.

2. A method, comprising:
receiving, with one or more processors, from a group leader's computing device, a request to initiate a group decision and one or more identifiers of members of a group requested to collectively help make the group decision;
obtaining, with one or more processors, a category of decision, the category of decision indicating the category of items among which the group is to choose;
obtaining, with one or more processors, candidate sub-categories within the category of decision;
sending, with one or more processors, computing devices of members of the group at least some of the candidate sub-categories to choose among;
receiving, with one or more processors, sub-category votes on at least some of the candidate sub-categories from at least some of the computing devices of the members of the group;
based on the sub-category votes, selecting, with one or more processors, a sub-category from among the candidate sub-categories;
sending, with one or more processors, the computing devices of members of the group candidate items within the selected sub-category, without sending at least some items in un-selected sub-categories;
receiving, with one or more processors, item votes on at least some of the candidate items from at least some of the computing devices of the members of the group; and
sending, with one or more processors, the group leader a group decision based on the item votes, wherein the decision is determined before all of the group members have voted on all of the items.

3. The method of claim 2, wherein:
the request to initiate a group decision is received by a group decision engine over the Internet;
the request is received with a geolocation specified by the group leader, the geolocation being specified by the computing device of the group leader sensing the geolocation or by the group leader explicitly entering the geolocation;
the group leader's computing device comprises a mobile computing device, the group leader being a group leader in virtue of sending the request to initiate the group decision;
the request to initiate a group decision is received separately from and before the one or more identifiers of members of the group;
the one or more identifiers of the members of the group include contact information for each member of the group retrieved from a set of contacts stored in memory of the mobile computing device of the group leader;
the group comprises four or more people, each having a different computing device through which the respective group member participates in the decision;
the category of decision includes restaurants and the group decision comprises choosing a restaurant from among more than 80 candidate restaurants based on choices made by each member of the group;
the sub-categories include sub-categories of restaurants, including varieties of cuisine;
the items include restaurants within the sub-categories of restaurants;
obtaining a category of decision comprises receiving, from the group leader's computing device, an indication of a selection by the group leader of a category from among categories including at least three of the following categories: restaurants, bars, events, gifts, destinations, lodging, flights, movies, video games, and television shows;
sending computing devices of members of the group candidate sub-categories comprises;
determining that the obtained category of decision relates to restaurants and, in response, selecting an application program interface (API) of a restaurant listing from among a plurality of different APIs for different categories of group decisions; and
sending an API request for restaurants to the restaurant listing, the API request requesting restaurants within a threshold distance to the geolocation of the group leader;
receiving a taxonomy of restaurants from the restaurant listing, the taxonomy including the sub-categories of restaurants and the restaurants within each sub-category of restaurant;
determining a plurality of different sequences with which the sub-categories are to be presented for voting on the computing devices of the group members, the sequences indicating an order in which the sub-categories are to be presented one at a time, one after another; and
sending at least part of the respective sequences and the sub-categories of restaurants to the computing devices of the group members;
selecting a sub-category comprises at least one of the following:
determining that a majority of the members of the group voted for the selected sub-category;
determining that the group leader chose the selected sub-category in view of the sub-category of votes; or
determining that more than a threshold amount of members of the group voted for the selected sub-category;
the sub-category votes include choices including at least three of the following: an indication that the group member does not care whether a respective sub-category is chosen, an indication that the group member vetoes a respective sub-category, a vote in favor of a respective sub-category, and a vote against a respective sub-category;
receiving sub-category votes on the sub-categories comprises:
receiving a given sub-category vote from a given group member on a given sub-category;
sending instructions to the computing devices of the other group members to change the respective sequences with which the sub-categories are presented for voting such that a vote against the given sub-category causes the given sub-category to be presented later in the respective sequence or a vote in favor of the given sub-category causes the given sub-category to be presented earlier in the respective sequence;
sending the group leader a group decision based on the item votes comprises;
tallying the item votes;
sending the group leader the group decision; and
receiving from the group leader a choice either consistent with or different from the group decision; and
the steps of claim 1 are performed in the order recited.

4. The method of claim 2, wherein the category of decision is:
obtained from the group leader's computing device; and
indicates a selection by the group leader of a category from among categories including at least two of the following categories: restaurants, bars, events, gifts, destinations, lodging, flights, movies, video games, and television shows.

5. The method of claim 2, comprising:
before sending the sub-categories, determining a plurality of different sequences to present at least part of the sub-categories for different group members, such that different group members vote on at least some of the sub-categories in a different order; and
sending at least part of the sequence selected for each respective group member to the respective group member's computing device, sending at least part of the sequence including sending sub-categories according to the sequence in response to sub-category votes or sending the entire sequence before sub-category votes are received.

6. The method of claim 2, comprising:
determining a sequence to present the sub-categories or the items to at least some of the group members based on logged votes by a given group member in past group decisions including the same group members.

7. The method of claim 6, wherein determining the sequence to present the sub-categories or the items comprises determining the sequence based on a correspondence with times at which the past group decisions were made.

8. The method of claim 2, comprising:
during a round of voting, adjusting a sequence with which the sub-categories or items are presented to a first group member from among the group members in response to a vote during the round of voting by a second group member from among the group members.

9. The method of claim 8, wherein adjusting the sequence comprises determining that an item or a sub-category subject to the vote by the second group member has not yet been presented to the first group member, and wherein the adjustment either:
causes an item or a sub-category the second group member voted in favor of to be presented earlier in the sequence to the first group member; or
causes an item or a sub-category the second group member voted against to be presented later in the sequence to the first group member.

10. The method of claim 9, wherein the first group member and the second group member are sent different items in a different sequence, and wherein the adjustment is made with a real-time database configured to synchronize application data across distributed clients.

11. The method of claim 2, comprising:
before sending the candidate items and after selecting the sub-category, sending a plurality of candidate sub-sub-categories within the selected sub-category to the computing devices of members of the group; and
receiving sub-sub-category votes on at least some of the candidate sub-sub-categories from at least some of the members of the group,
wherein sending the computing devices of members of the group candidate items within the selected sub-category comprises:
based on the sub-sub-category votes, selecting a sub-sub-category from among the candidate sub-sub-categories; and
sending the computing devices of members of the group one or more sets of candidate items within the selected sub-sub-category, without sending at least some candidate items within un-selected sub-sub-categories.

12. The method of claim 2, wherein the decision is determined without all group members voting on all sub-categories.

13. The method of claim 2, comprising:
determining the group decision in response to receiving more than a threshold amount of item-votes in favor of a given item without waiting for all group members to vote on all of the items.

14. The method of claim 13, wherein:
the sub-category is selected in response to receiving more than a threshold amount of item-votes in favor of a given sub-category without waiting for all group members to vote on all of the sub-categories.

15. The method of claim 2, comprising:
determining that a threshold duration of time has elapsed since sending the candidate sub-categories; and
in response to determining that the threshold duration of time has elapsed, selecting the sub-category based on sub-category votes received without waiting for group consensus.

16. The method of claim 15, wherein the threshold duration is determined based on an amount of time elapsed since a sub-category vote was last received.

17. The method of claim 2, comprising:
maintaining a persistent transmission control protocol (TCP) connection with a given computing device among the computing devices of the group members;
pushing an update to a sequence with which items are to be presented for voting to the given computing device via the persistent TCP connection without waiting for a pull-request from the given computing device.

18. The method of claim 17, wherein the persistent TCP connection is established and maintained responsive to a native application executing in the foreground of the given computing device.

19. The method of claim 17, wherein sending the update comprises sending a difference between a previously sent sequence and a new sequence without sending a complete copy of the new sequence.

20. The method of claim 2, comprising:
composing an application program interface (API) request based on the group decision; and
sending the API request to a service that fulfils at least part of a choice of the group decision.

21. The method of claim 20, wherein the API request includes at least one of the following:
a request for an offer associated with the item selected by the group;
a request to add an event to a calendar of a member of the group based on a date indicated by the group decision or by the request to initiate the group decision;
a request for a route to a geolocation where the item selected by the group is located;
a request to reserve or view available capacity at or of the item selected by the group;
a request to establish an online group fund for paying for the item selected by the group;
a request to obtain transportation to the item selected by the group;
a request to view weather forecasted for the geolocation of the item selected by the group; or
a request to order a delivery of services for or from the item selected by the group.

22. The method of claim 2, comprising:
selecting an advertisement or an offer based on at least some of the item votes or the sub-category votes; and
causing the selected advertisement or offer to be sent to at least some of the members of the group.

23. A system, comprising:
one or more processors; and
memory storing instructions that when executed by at least some of the one or more processors causes the one or more processors to effectuate operations comprising:
receiving, from a group leader's computing device, a request to initiate a group decision and one or more identifiers of members of a group requested to collectively help make the group decision;
obtaining a category of decision, the category of decision indicating the category of items among which the group is to choose;
obtaining candidate sub-categories within the category of decision;
sending computing devices of members of the group at least some of the candidate sub-categories to choose among;
receiving sub-category votes on at least some of the candidate sub-categories from at least some of the computing devices of the members of the group;
based on the sub-category votes, selecting a sub-category from among the candidate sub-categories;
sending the computing devices of members of the group candidate items within the selected sub-category, without sending at least some items in un-selected sub-categories;
receiving item votes on at least some of the candidate items from at least some of the computing devices of the members of the group; and
sending the group leader a group decision based on the item votes, wherein the decision is determined before all of the group members have voted on all of the items.

24. A method, comprising:
receiving from a group-leader, with a mobile device, a request to initiate a group decision;
in response to the request to initiate a group decision, retrieving, from memory of the mobile device, contacts of the group leader;
presenting at least some of the contacts to the group leader with the mobile device;
receiving, with the mobile device, group-leader selections of group members from among the contacts;
sending identifiers of the group members and an indication of the request to initiate the group decision from the mobile device to a remote group decision engine;
sending, with the group decision engine, to the group members an invitation to participate in the group decision;
requesting, with the group decision engine, from a remote service, a taxonomy of candidate items among which the members of the group will select in the group decision, the taxonomy specifying the candidate items and categories of the candidate items;
sending, from the group decision engine, at least some of the categories of the candidate items to mobile devices of the group members;
presenting, as part of a round of voting, with the mobile devices of the group members, the categories one at a time to the group members in accordance with one or more initial rankings;
receiving, with the group decision engine, an indication that a given category was selected by a given group member;
adjusting the initial rankings of the other group members to cause the given category to be presented sooner than in the un-adjusted initial rankings;
determining with the group decision engine that the round is complete;
presenting, as part of a subsequent round, candidate items within a category selected by the group and not presenting at least some candidate items within a category not selected by the group;
receiving selections among the candidate times;
determining that the subsequent round is complete; and
presenting to the group leader an indication of selections of the candidate items of members of the group.
